(19) United States
(12) Patent Application Publication
(10) Pub. No.: US 2025/0220124 A1
(43) Pub. Date: Jul. 3, 2025

(54) IMAGE READING DEVICE AND IMAGE FORMING APPARATUS

(71) Applicant: Atsushi SUGAI, Kanagawa (JP)

(72) Inventor: Atsushi SUGAI, Kanagawa (JP)

(73) Assignee: Ricoh Company, Ltd., Tokyo (JP)

(21) Appl. No.: 18/978,417

(22) Filed: Dec. 12, 2024

(30) Foreign Application Priority Data
Dec. 27, 2023 (JP) 2023-221397

(51) Int. Cl. H04N 1/028; G03G 15/22

(52) U.S. Cl. CPC H04N 1/02825; G03G 15/228; H04N 2201/0081

(57) ABSTRACT

An image reading device includes a visible light source to irradiate a document with a visible light beam, an infrared light source to irradiate the document with an infrared light beam, and multiple mirrors disposed in optical paths of the visible light beam and the infrared light beam from the document to an imaging device. The multiple mirrors include at least a mirror having a reflectance of 93% or more, at a reflection angle of 45°, to a light beam having a wavelength range of 450 nm or more and 900 nm or less.

### CROSS-REFERENCE TO RELATED APPLICATIONS

This patent application is based on and claims priority pursuant to 35 U.S.C. § 119 (a) to Japanese Patent Application No. 2023-221397, filed on Dec. 27, 2023, in the Japan Patent Office, the entire disclosure of which is hereby incorporated by reference herein.

### BACKGROUND

### Technical Field

Embodiments of the present disclosure relate to an image reading device, and an image forming apparatus.

### Related Art

In the related art, some image reading devices including a visible light source to irradiate a document with a visible light beam, an infrared light source to irradiate an infrared light beam to the document, and multiple mirrors disposed in optical paths of the visible light beam and infrared light beam from the document to an imaging device are known.

For example, in the related art, an image reading device including a visible light source and an infrared light source can read an invisible non-copying pattern of the document by turning on the infrared light source. When the invisible non-copying pattern is read, the image reading device stops the copying operation.

However, at least one of the amount of visible light beam or the amount of infrared light beam incident on the imaging device may be smaller than the amount of light beam required for reading by the imaging device.

### SUMMARY

According to an embodiment of the present disclosure, an image reading device includes a visible light source to irradiate a document with a visible light beam, an infrared light source to irradiate the document with an infrared light beam, and multiple mirrors disposed in optical paths of the visible light beam and the infrared light beam from the document to an imaging device. The multiple mirrors include at least a mirror having a reflectance of 93% or more, at a reflection angle of 45°, to a light beam having a wavelength range of 450 nm or more and 900 nm or less.

According to an embodiment of the present disclosure, an image forming apparatus includes the image reading device to read an image on the document, and an image forming device to form the image, read by the image reading device, on a sheet.

According to an embodiment of the present disclosure, an image reading device includes a visible light source to irradiate a document with a visible light beam, an infrared light source to irradiate the document with an infrared light beam, and multiple mirrors disposed in optical paths of the visible light beam and the infrared light beam. The multiple mirrors includes at least a mirror having a reflectance uniformity of 96% or more, at a reflection angle of 45°, to a light beam having a wavelength range of 450 nm or more and 900 nm or less. The reflectance uniformity is defined by a following expression, (minimum reflectance/maximum reflectance)×100%.

According to an embodiment of the present disclosure, an image forming apparatus includes the image reading device to read an image on the document, and an image forming device to form the image, read by the image reading device, on a sheet.

According to an embodiment of the present disclosure, an image reading device includes a visible light source to irradiate a document with visible light beam, an infrared light source to irradiate the document with an infrared light beam, and multiple mirrors disposed in optical paths of the visible light beam and the infrared light beam from the document to an imaging device. The multiple mirrors include at least a surface reflection mirror made of a metal film material of silver.

According to an embodiment of the present disclosure, an image forming apparatus includes the image reading device to read an image on the document and an image forming device to form the image, read by the image reading device, on a sheet.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus according to an embodiment of the present disclosure;

FIG. 2 is a perspective view of a scanner unit;

FIG. 3 is a perspective view of the inside of the scanner unit of FIG. 2;

FIG. 4 is a schematic diagram illustrating a configuration of a one-body scanner unit;

FIG. 5 is a perspective view of a board with white point light sources and infrared point light sources arranged in an array on a mounting surface of the board;

FIG. 6 is a diagram illustrating reflection angles of reflection mirrors in a main scanning direction;

FIG. 7 is a graph of a reflectance of an aluminum mirror with a protective film at reflection angles of 5° and 45° with varying wavelengths;

FIG. 8 is a graph of a reflectance of an enhanced reflection aluminum mirror at reflection angles of 5° and 45° with varying wavelengths;

FIG. 9 is a graph of reflectance of a silver mirror at reflection angles of 5° and 45° with varying wavelengths;

FIG. 10 is a graph of reflectance of another silver mirror with varying wavelengths;

FIG. 11 is a graph of image sensor outputs at each position in the main scanning direction in the case where all reflection mirrors are aluminum mirrors and in the case where half of the aluminum mirrors are replaced by silver mirrors; and

FIG. 12 is a schematic diagram illustrating a scanner unit of an image reading unit applying a differential mirror system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to an embodiment of the present disclosure, the amount of visible light beam and the amount of infrared light beam incident on the imaging device can be prevented from being below the amount of light beam required for reading by the imaging device.

Embodiments of the present disclosure will be described with reference to the drawings. It is easy for a person skilled in the art to make other embodiments by changing and modifying the embodiments of the present disclosure within the scope of the claims, and these changes and modifications are included in the scope of the claims. In the following description, the embodiments of the present disclosure are examples of the best mode of the disclosure and are not intended to limit the scope of the claims.

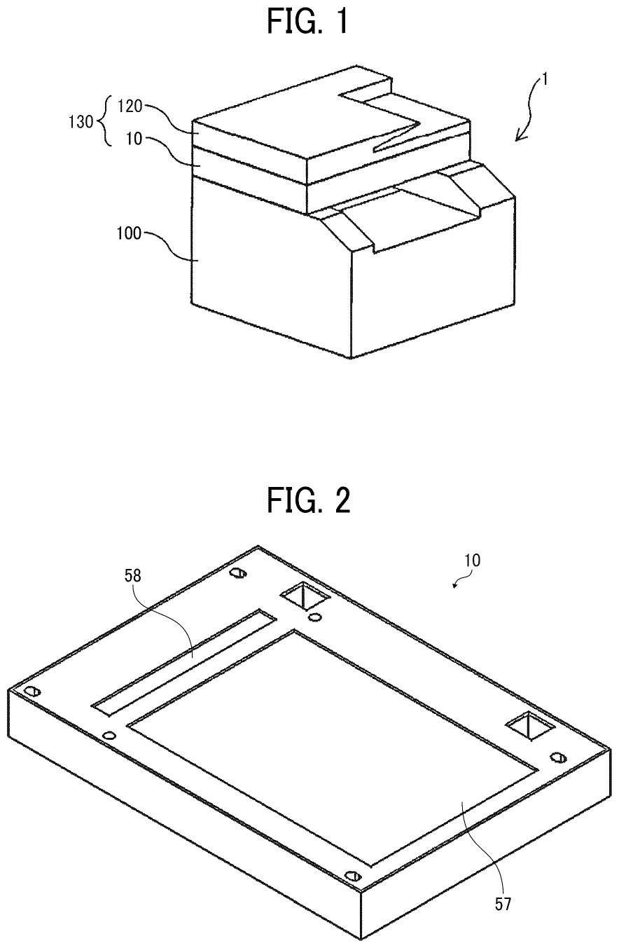

An embodiment of the present disclosure applied to an image forming apparatus including an image reading device will be described below. FIG. 1 is a perspective view of an image forming apparatus 1 according to an embodiment of the present disclosure. The image forming apparatus 1 illustrated in FIG. 1 has functions of a copying machine, a printer, a facsimile machine, and a scanner, and can record a full-color image or a monochrome image on a recording sheet based on input data such as read image data, or output the image in a predetermined data format.

The image forming apparatus 1 includes an image forming unit 100 with a sheet feeder, a scanner unit 10, and an automatic document feeder (ADF) 120 above the scanner unit 10. A main body of the image forming apparatus includes the scanner unit 10, and the image reading device 130 includes the scanner unit 10 and the ADF 120.

The sheet feeder of the image forming unit 100 includes multiple sheet feeding cassettes for storing cut recording sheets, and multiple pairs of sheet feeding rollers that pick up and feed a recording sheet from any of the sheet feeding cassettes. The sheet feeder has a sheet feeding path including various rollers that convey the recording sheet fed from any of the sheet feeding rollers to a predetermined position for image forming in the image forming unit 100.

The image forming unit 100 includes, for example, an exposure unit, multiple photoconductive drums, a developing device using four color toners of cyan (C), magenta (M), yellow (Y), and black (K), a transfer unit, a secondary transfer unit, and a fixing unit.

For example, the image forming unit 100 forms an electrostatic latent image on each of the photoconductive drums by exposing the photoconductive drums of the respective colors to light in the exposure unit based on the image read by the image reading device 130, and develops the electrostatic latent image on each of the photoconductive drums by supplying toner to the electrostatic latent image in the developing unit of the developing device. The image forming unit 100 primarily transfers the toner images on the photoconductive drums of the respective colors to a transfer belt, secondarily transfers the toner images on a recording sheet by a secondary transfer unit so as to superimpose the toner images, and fixes the toner images onto the recording sheet by heating and pressurizing the toner images with a fixing unit. As a result, a color image is formed. Further, the image forming unit 100 can form an external output image such as an image file or data that can be output to the outside based on the image read by the scanner unit 10. Instead of the image forming unit 100 of the electrophotographic system as described above, an image forming unit employing another recording system such as an inkjet system may be used.

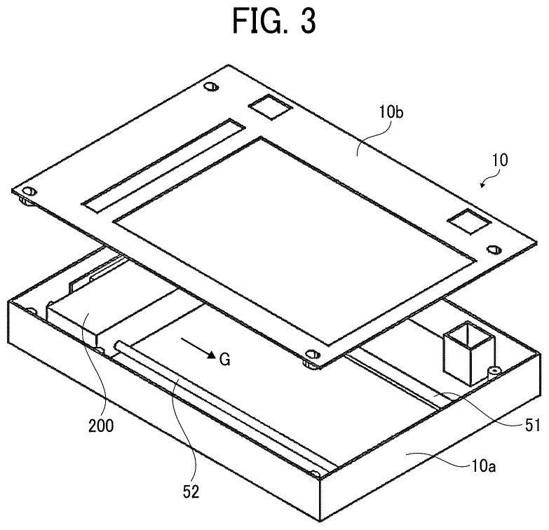

FIG. 2 is a perspective view of a scanner unit 10. The ADF 120 is disposed on the scanner unit 10 and is movably supported by a hinge, so that the upper surface of the scanner unit 10 can be opened and closed. A contact glass 57 and a slit glass 58 as transparent members are disposed on the upper surface of the scanner unit 10.

FIG. 3 is a perspective view of the inside of the scanner unit 10. As illustrated in FIG. 3, the scanner unit 10 includes a housing 10a of a substantially rectangular parallelepiped box-like member that accommodates the one-body scanner unit 200, and a scanner cover 10b attached to the housing 10a so as to close the upper surface of the housing 10a. The one-body scanner unit 200 is supported by a guide rod 52 and a guide rail 51 attached to the housing 10a in the left-right direction in FIG. 3 so as to be movable in the direction of arrow G in FIG. 3.

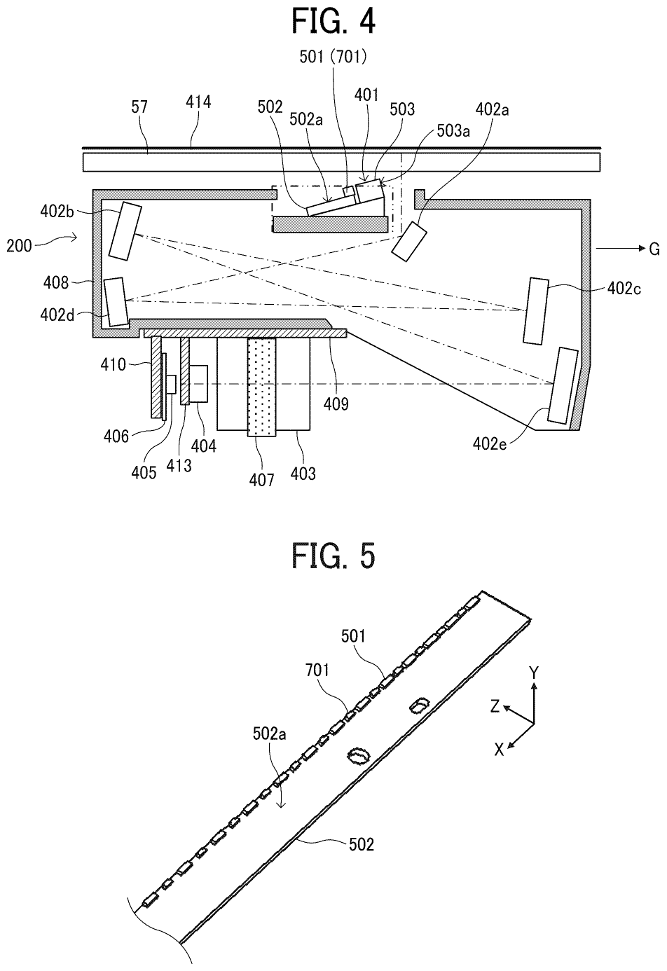

FIG. 4 is a schematic diagram illustrating a configuration of a one-body scanner unit 200. As illustrated in FIG. 4, a frame 408 of the one-body scanner unit 200 accommodates an illumination device 401. The one-body scanner unit 200 also accommodates five reflection mirrors 402a, 402b, 402c, 402d, and 402e to reflect the light beam reflected from the document 414 as an object to be imaged, and a first lens group 403 and a second lens group 404 to image the reflected light beam reflected from these reflection mirrors. Further, the one-body scanner unit 200 accommodates the image sensor 405 as an imaging device that photoelectrically converts the light beam imaged by the first lens group 403 and the second lens group 404, and the driving circuit board 406. The driving circuit board 406 outputs an image signal based on the electrical signal output from the image sensor 405.

The first lens group 403 disposed at a side of the reflection mirror 402e is fixed to a lens receiving table 409 with a lens band 407. The second lens group 404 disposed at a side of the image sensor 405 is fixed to a lens receiving table 409 with a lens fixing bracket 413.

The first lens group 403 is a lens having a positive power, and the second lens group 404 is a lens having a negative power. In the present embodiment, the first lens group 403 having a positive power and the second lens group 404 having a negative power are used. Accordingly, chromatic aberration can be corrected, and an image having a high resolution can be formed on the image sensor 405. In addition, the focal length can be shortened, and the size of the one-body scanner unit 200 can be reduced. Further, a distance from the second lens group 404 to the image sensor 405, which is referred to as a back focus, can be also shortened, and the size of the one-body scanner unit 200 can be reduced.

The driving circuit board 406 on which the image sensor 405 is mounted is attached to the lens receiving table 409 via a fixing bracket 410. As the image sensor 405, a charge-coupled device (CCD) or a complementary metal oxide semiconductor (CMOS) can be used. The image sensor 405 of the present embodiment can capture images in the visible light region and the infrared light region.

The illumination device 401 includes a board 502 on which multiple white point light sources 501 and infrared point light sources 701 that irradiate an object with light beams are arranged in an array on a mounting surface 502a. Further, the illumination device 401 includes a light guide 503 that guides the light beams emitted from the white point light sources 501 and the infrared point light source 701 to an illumination area of the document. The light guide 503 is made of a resin having a high transmittance such as acrylic resin, and a diffusing agent as a diffusing material is applied to the emission surface 503a. When the light beams from the white point light sources 501 and the infrared point light source 701 are emitted from the emission surface 503a of the light guide 503, the light beams are diffused. Accordingly, variations in the illuminance and chromaticity in the main scanning direction (i.e., the width direction of the document) on the document surface due to variations in chromaticity and illuminance of the point light sources can be prevented.

The document surface of the document 414 that is an irradiation object placed on the contact glass 57 is irradiated with the white light beam and the infrared light beam emitted from the illumination device 401. The light beam reflected from the surface of the document 414 is reflected by the five reflection mirrors 402a, 402b, 402c, 402d, and 402e. The reflected and guided light beam passes through the first lens group 403 and the second lens group 404, enters the image sensor 405, and is received by the image sensor 405. As a result, an image of the document surface is read.

As the one-body scanner unit 200 moves in the direction of arrow G in FIG. 4, the image sensor 405 sequentially reads the image of the surface of the document placed on the contact glass 57, and reads the image of the entire document surface.

When an image on the surface of the document conveyed by the automatic document feeder (ADF) 120 is read, the one-body scanner unit 200 is positioned at the home position illustrated in FIG. 3. When the one-body scanner unit 200 is positioned at the home position, the slit glass 58 is irradiated with the light beam from the illumination device 401. Accordingly, the image on the surface of the document that is conveyed by the ADF 120 to pass over the slit glass 58 is read by the image sensor 405.

FIG. 5 is a perspective view of a board 502 with white point light sources 501 and infrared point light sources 701 arranged in an array on a mounting surface 502a of the board 502. The multiple white point light sources 501 are arranged in an array in the main scanning direction (i.e., width direction of the original). The multiple white point light sources 501 are side-view type light emitting diodes (LEDs), and the light irradiation surface is disposed so as to be perpendicular to the mounting surface 502a and in the same plane as the end surface of the end of the board 502. The emission wavelength of the white point light source is about 450 to 780 nanometers (nm).

The infrared point light source 701 is disposed between the white point light sources 501. The infrared point light source 701 is also a side-view type LED, and is mounted on the board 502 so that the light irradiation surface is perpendicular to the mounting surface 502a. The emission wavelength of the infrared point light source is about 850 to 900 nm.

Since the infrared point light source 701 is disposed between the white point light sources 501, the document image with the white light beam and the document image with the infrared light beam can be read. For example, when the character recognition of the document image is performed by an optical character recognition/reader (OCR), the document is irradiated with the infrared light beam to read the document image. Since the document image is irradiated with the infrared light, the color of the document image can be canceled. As a result, the accuracy of character recognition can be increased.

In addition, since the document is irradiated with the infrared light beam, an infrared (IR) image (i.e., an image visualized by infrared light irradiation) can be read. For example, an IR image formed for preventing forgery and printed on an various certificates or a confidential document is read by irradiating the IR image with infrared light beam, and when the IR image is present, the copying is prohibited. Accordingly, forgery can be prevented. Alternatively, the IR image read by IR beam irradiation may be printed with a visible toner such as a black toner to indicate that the printing is a copy. As a result, forgery can be prevented.

As illustrated in FIG. 4, the one-body scanner unit 200 includes five reflection mirrors 402a, 402b, 402c, 402d, and 402e. The reflected light beam reflected on the document surface is reflected by the reflection mirrors many times, and finally reaches the image sensor 405. The amount of light beam that reaches the image sensor 405 decreases according to the reflectance of the reflection mirror and the number of reflections. As a result, the image sensor 405 may not read an IR image or a visible image of a predetermined quality.

In order to set the amount of white light beam and the amount of infrared light beam that reaches the image sensor 405 to a predetermined amount, the amount of light irradiation from the white point light source 501 and the amount of light irradiation from the infrared point light source 701 may be increased. However, since there are layout restrictions of the illumination device, the amount of light irradiation that requires for the predetermined amount of white light beam and infrared light beam that reaches the image sensor 405.

In particular, the one-body scanner unit 200 needs to use a large number of reflection mirrors in order to increase the imaging distance within the frame 408 having a limited layout. Thus, the number of reflection is increased, and the amount of light beam is largely decreased due to the reflection mirrors.

In the one-body scanner unit 200, the first lens group 403 has a wide angle of view. Thus, in the case of a reflection mirror having a high reflectance dependency on the reflection angle (i.e., reflectance largely varies depending on the reflection angle), the amount of light beam incident on the image sensor 405 largely varies in the main scanning direction.

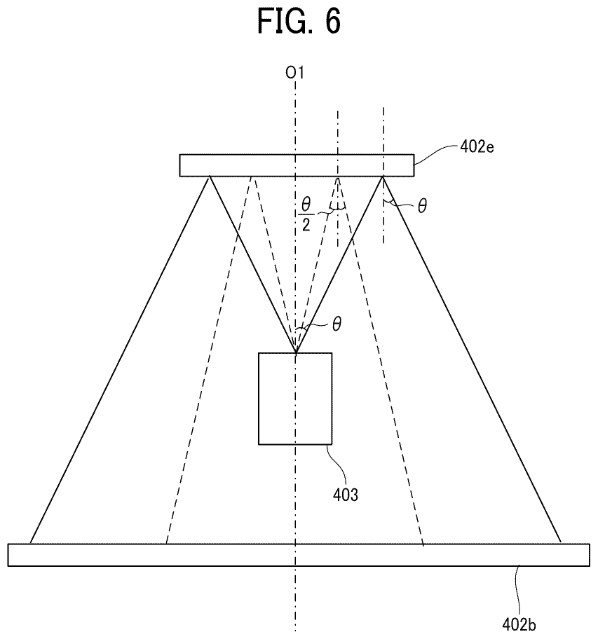

FIG. 6 is a diagram illustrating reflection angles of reflection mirrors in a main scanning direction. When the half angle of view of the first lens group 403 is θ, the reflection angles at the both ends in the main scanning direction are the same as the half angle of view of the first lens group 403. The reflection angle at the center O1 in the main scanning direction is 0°, and the reflection angle at the intermediate position, which is indicated by the broken line in FIG. 6, between the center O1 and the end in the main scanning direction is θ/2. As described above, in the range from 0° to the half angle of view θ of the first lens group 403, the reflection angle of the reflection mirror in the main scanning direction gradually increases toward the end in the main scanning direction. The larger the half angle of view of the first lens group 403, the larger the difference in the reflection angle between the center and the end in the main scanning direction.

As described above, in the one-body scanner unit 200, since the first lens group 403 has a wide angle of view, the difference in the reflection angle between the center and the end in the main scanning direction is large. As a result, when a reflection mirror having a high reflectance dependency on the reflection angle is used as the reflection mirror, a difference between the amount of light beam incident on the image sensor 405 at the center in the main scanning direction and the amount of light beam at the end in the main scanning direction becomes large. Thus, an image may not be read well.

In the present embodiment, the five reflection mirrors 402a, 402b, 402c, 402d, and 402e include at least one surface reflection mirror having a metal reflection film material of silver (referred to as a silver mirror).

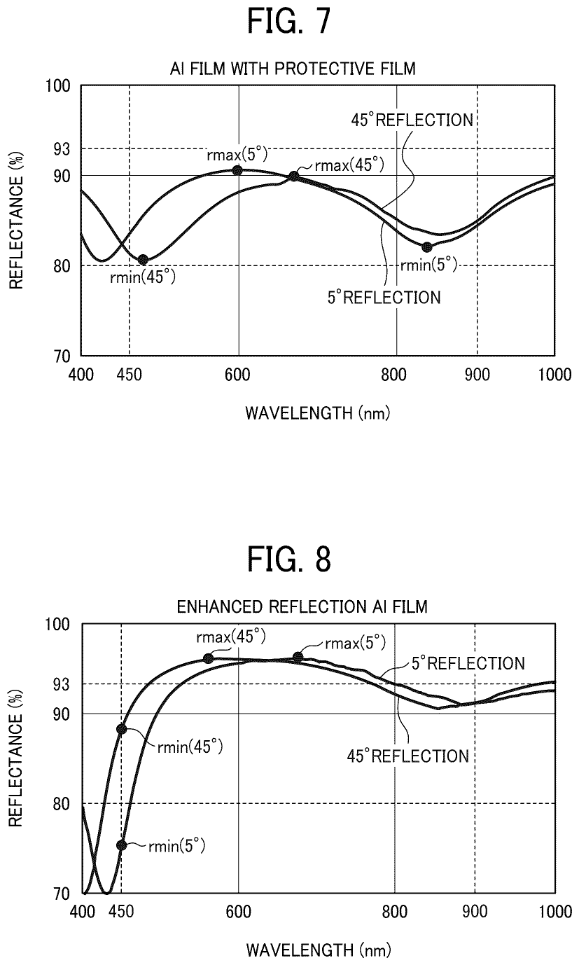

FIG. 7 is a graph of reflectance of an aluminum mirror with a protective film at reflection angles of 5° and 45° with varying wavelengths. The reflectance of each wavelength was measured using a spectrophotometer. In the aluminum mirror with a protective film, in the wavelength range of 450 nm to 900 nm at a reflection angle of 5°, the maximum reflectance rmax (5°) was about 90%, the minimum reflectance rmin (5°) was about 82%, and the reflectance uniformity (=(minimum reflectance/maximum reflectance)×100%) was about 91%, which was less than 96%.

In the aluminum mirror with a protective film, in the wavelength range of 450 nm to 900 nm at a reflection angle of 45°, the maximum reflectance rmax (45°) was about 90%, the minimum reflectance rmin (45°) was about 81%. In the wavelength range of 450 nm to 900 nm at a reflection angle of 45°, the reflectance uniformity (=(minimum reflectance/maximum reflectance)×100%) was about 90%, which was less than 96%.

As illustrated in FIG. 7, the aluminum mirror with a protective film had a maximum reflectance of about 90% in the wavelength range of 450 nm to 900 nm. In the case of the aluminum mirror with a protective film, the amount of light beam decreases by 10% or more in a single reflection. As a result, in the one-body scanner unit 200 according to the present embodiment using the five reflection mirrors 402a, 402b, 402c, 402d, and 402e, the amount of white light beam and the amount of infrared light beam that reach the image sensor 405 are largely decreased. Thus, the visible light image and the infrared light image may not be read well.

The aluminum mirror with a protective film has poor reflectance uniformity less than 96%, and has a poor reflectance of the light beam in a wavelength range around 450 nm and a poor reflectance of the near-infrared light beam around 850 nm. Thus, the amount of blue light beam and the amount of near-infrared light beam incident on the image sensor may be less than a predetermined amount of light beam, and the blue image and the infrared image may not be read well.

In addition, the aluminum mirror with a protective film has a large reflectance at a reflection angle of 5° and a large reflectance at a reflection angle of 45° around a wavelength of 450 nm, and reflectance characteristics are different at a reflection angle of 5° and a reflection angle of 45°. Thus, in the aluminum mirror with a protective film, since a lower reflection angle has a higher reflectance around the wavelength of 450 nm, the blue image at the end in the main scanning direction becomes darker than that at the center in the main scanning direction. As a result, the color of the read visible light image largely differs between the center and the end in the main scanning direction, and the reading quality of the visible light image is poor.

FIG. 8 is a graph of reflectance of an enhanced reflection aluminum mirror at reflection angles of 5° and 45° with varying wavelengths. The enhanced reflection aluminum mirror is formed by applying a dielectric multilayer film to the surface of aluminum, and as can be understood from the comparison between FIGS. 7 and 8, the enhanced reflection aluminum mirror has a higher reflectance than the aluminum mirror with a protective film. However, in the case of the enhanced reflection aluminum mirror, in a wavelength range of 450 nm to 900 nm, the reflectance of light beam at a wavelength of around 450 nm and the reflectance of near-infrared light bema at a wavelength of around 850 nm are less than 93%. Thus, the blue image and the infrared image may not be read well even with the aluminum mirror with a protective film.

In a wavelength range of 450 nm to 900 nm, the reflectance uniformity at a reflection angle of 5° for the enhanced reflection aluminum mirror is about 82%, and the reflectance uniformity at a reflection angle of 45° is about 95%, which is less than 96%.

The enhanced reflection aluminum mirror also has a high reflectance dependency on a reflection angle at a wavelength around 450 nm, and reflectance characteristics are different between the reflection angle is 5° and the reflection angle is 45°. In the case of the enhanced reflection aluminum mirror, since the higher the reflection angle is, the higher the reflectance is at a wavelength around 450 nm, a blue image at the center in the main scanning direction becomes darker than the blue image at the end in the main scanning direction. As a result, the color of the visible light image largely differs between the center and the end in the main scanning direction also in the case of the enhanced reflection aluminum mirror, and the reading quality of the visible light image is poor.

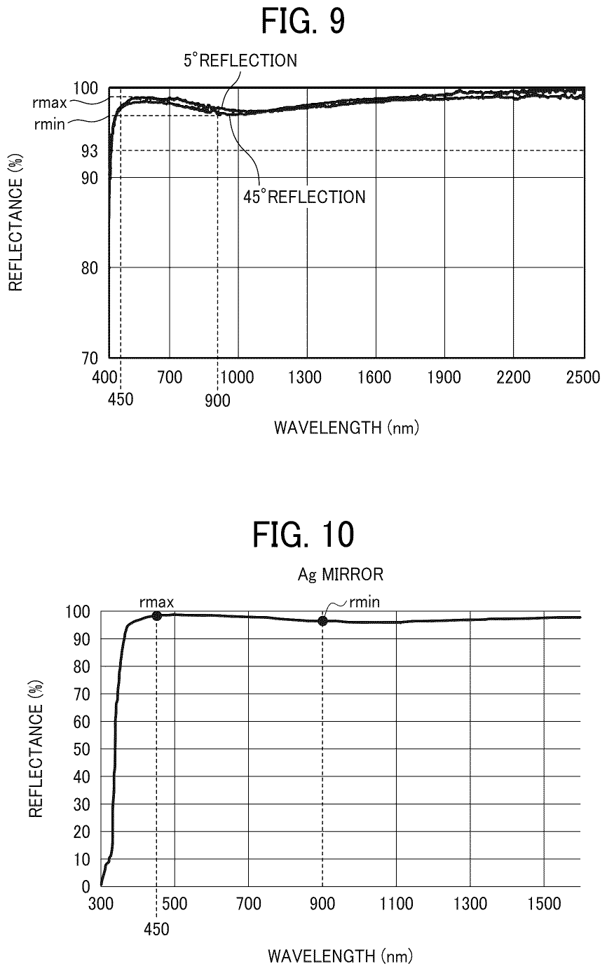

FIG. 9 is a graph of reflectance of a silver mirror at reflection angles of 5° and 45° with varying wavelengths. As illustrated in FIG. 9, the silver mirror has a high reflectance of 93% or more at both reflection angles of 5° and 45° for all wavelengths of 450 nm to 900 nm. In addition, a reflectance uniformity (=(minimum reflectance/maximum reflectance)×100%) in a wavelength range of 450 nm to 900 nm was about 97% at both reflection angles of 5° and 45°, and the reflectance uniformity was 96% or more. Thus, a constant reflectance can be obtained from visible light to near-infrared light, and both the visible light image and the infrared light image can be read well.

Further, the silver mirror has similar reflectance characteristics at reflection angles 5° and 45° and a low reflectance dependency on a reflection angle. As a result, the amount of light beam incident on the image sensor 405 can be uniform in the main scanning direction for all wavelengths of 450 nm to 900 nm. Accordingly, an occurrence of a dark portion of the read image in the main scanning direction can be prevented. In addition, an occurrence of a difference in color between the end and the center of the read visible light image in the main scanning direction and an occurrence of a difference in brightness between the end and the center of the read infrared light image in the main scanning direction can be prevented. Thus, the visible light image and the infrared light image can be read well. The similar reflectance characteristics described above indicates that a difference between the reflectance at a reflection angle of 5° and the reflectance at a reflection angle of 45° with varying wavelengths in a wavelength range of 450 nm to 900 nm is 7% or less.

FIG. 10 is a graph of reflectance of another silver mirror with varying wavelengths. This silver mirror also has a high reflectance of 93% or more, and a reflectance uniformity (=(minimum reflectance/maximum reflectance)×100%) is 98% or more, and a constant reflectance can be obtained from visible light to near-infrared light.

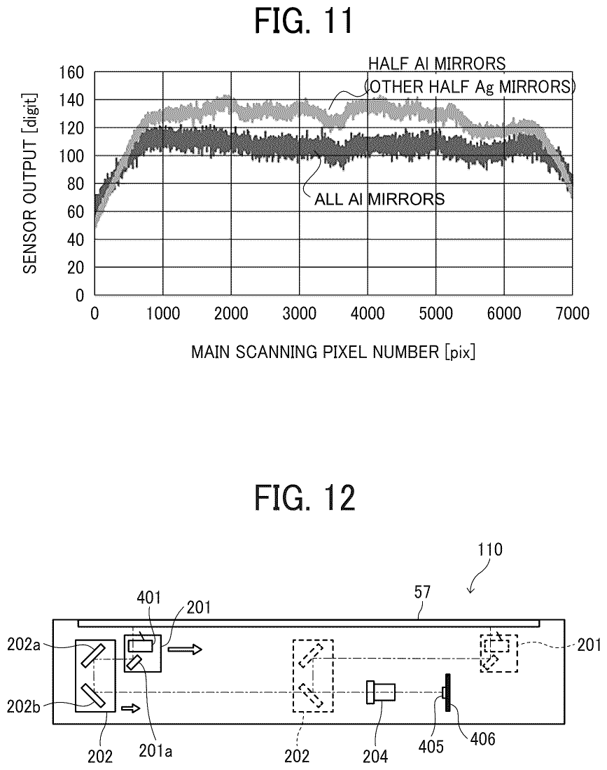

FIG. 11 is a graph of image sensor outputs at each position in the main scanning direction in the case where all reflection mirrors are aluminum mirrors and in case where half of the aluminum mirrors are replaced by silver mirrors. As can be understood from FIG. 11, since the silver mirrors are used, the output from the image sensor 405 can be increased as compared with the case where all the reflection mirrors are aluminum mirrors. As a result, the document image can be read well. As described above, since the five reflection mirrors 402a, 402b, 402c, 402d, or 402e include at least one silver mirror, the amount of visible light beam and near-infrared light beam that reach the image sensor 405 can be prevented from decreasing. Accordingly, the amount of light beam incident on the image sensor 405 can be increased to a predetermined level or more. Further, since the reflectance uniformity becomes higher, the amount of light beam is not decreased at a specific wavelength. Thus, the visible light image and the infrared light image can be read well.

Since the silver mirror is more expensive than the aluminum mirror or the enhanced reflection aluminum mirror, it is preferable to use the silver mirror as the reflection mirror having a small reflection area among the reflection mirrors 402a, 402b, 402c, 402d, and 402e. In the present embodiment, the reflection mirror 402e disposed at the most downstream position in the light propagation direction has the shortest length in the main scanning direction and has the smallest reflection area. Thus, it is preferable to use a silver mirror for the reflection mirror 402e. As described above, since the silver mirror is applied to a reflection mirror having smallest reflection area, the cost of the apparatus can be prevented from increasing.

FIG. 12 is a schematic diagram illustrating a scanner unit 110 of an image reading unit applying a differential mirror system. As illustrated in in FIG. 12, the scanner unit 110 of the image reading unit applying a differential mirror system includes a first carriage 201 and a second carriage 202. The first carriage 201 includes an illumination device 401 and a first reflection mirror 201a. The second carriage 202 includes a second reflection mirror 202a and a third reflection mirror 202b.

When image reading is started, the illumination device 401 irradiates the document placed on the contact glass with the white light beam and the infrared light beam, and the first carriage 201 is moved from the left side to the right side in FIG. 12. Further, the second carriage 202 is moved to the right side in FIG. 12 at half speed of the first carriage 201. In this way, the second carriage 202 moves in the same direction as the first carriage 201 at half speed of the first carriage 201, so that the optical path length of the light beam from the document surface to the imaging lens 204 does not change.

In the process of moving the first and second carriages 201 and 202 from the left side to the right side in FIG. 12 at a speed ratio of 2:1, a light beam emitted from the illumination device 401 is reflected by the document placed on the contact glass 57. The reflected light beam from the document is guided to the imaging lens 204 via the first reflection mirror 201a, the second reflection mirror 202a, and the third reflection mirror 202b, and an image is formed on the image sensor 405. Accordingly, a document image is read.

In the image reading unit applying the differential mirror system, the three reflection mirrors include at least one silver mirror. As a result, the three reflection mirrors include at least one mirror having a reflectance of 93% or more at both reflection angles of 5° and 45° for all wavelengths of 450 nm to 900 nm. Further, three reflection mirrors include at least one mirror having a reflectance uniformity (=(minimum reflectance/maximum reflectance)×100%) of 96% or more in a wavelength range of 450 nm to 900 nm.

Accordingly, the amount of light beam incident on the image sensor 405 can be prevented from decreasing, and the visible light image and the infrared light image of the document can be read well. Further, since the mirror has a low reflectance dependency on the reflection angle, the occurrence of a dark portion in the main scanning direction can be prevented in the read image, and the visible light image and the infrared light image of the document can be read well.

As described above, some preferable embodiments of the present disclosure have been described. However, the present disclosure is not limited to the above-described embodiments, and various modifications or changes can be made within the scope of the present disclosure described in the claims below.

In the present embodiment, the multiple reflection mirrors include at least one silver mirror, but the present disclosure is not limited to a silver mirror, and at least one mirror having the following reflection characteristics may be disposed. In other words, the mirror has reflection characteristics in which the reflectance of light in a wavelength range of 450 nm to 900 nm at a reflection angle of 45° is 93% or more, and reflection characteristics in which the reflectance uniformity of the light in a wavelength range of 450 nm to 900 nm is 96% or more.

As described above, aspects and advantageous effect of the present disclosure are, for example, as follows.

### FIRST ASPECT

An image reading device such as a scanner unit 10 includes a visible light source such as a white point light source 501 to irradiate a document with a visible light beam, an infrared light source such as an infrared point light source 701 to irradiate the document with an infrared light beam, and multiple mirrors disposed in optical paths of the visible light beam and the infrared light beam from the document to an imaging device such as an image sensor 405. The multiple mirrors include at least one mirror having a reflectance of 93% or more to a light beam having a wavelength range of 450 nm or more and 900 nm or less at a reflection angle of 45°.

A visible light beam of 450 nm to 780 nm and an infrared light beam (near-infrared light beam) of 800 nm to 900 nm reflected by the document are reflected by the mirrors multiple times before reaching the imaging device. Since the amount of visible light beam and the amount of infrared light beam are decreased according to the reflectance of the mirror and the reflection times, at least one of the amount of the visible light beam or the amount of infrared light beam incident on the imaging device may be below the amount of light beam required for the imaging device. However, in the first aspect, since the multiple mirrors include at least one mirror having a reflectance of 93% or more to the light beam having a wavelength range of 450 nm or more and 900 nm or less at a reflection angle of 45°, the loss of the amount of visible light beam and the loss of the amount of infrared light beam due to the mirror reflection can be decreased. As a result, the amount of visible light beam and infrared light beam incident on the imaging device can be prevented from being below the amount of light beam required for the imaging device, and the visible light image and the infrared light image of the document can be read by the imaging device well.

### SECOND ASPECT

An image reading device such as scanner unit 10 includes a visible light source such as a white point light source 501 to irradiate a document with a visible light beam, an infrared light source such as an infrared point light source 701 to irradiate the document with an infrared light beam, multiple mirrors disposed in optical paths of the visible light beam and the infrared light beam from the document to an imaging device such as an image sensor 405. The multiple mirrors include at least one mirror having a reflectance uniformity of 96% or more to a light beam having a wavelength range of 450 nm or more and 900 nm or less at a reflection angle of 45°. The light reflectance uniformity is defined by the following expression, (minimum reflectance)/(maximum reflectance)×100%. As a result, as described in an embodiment, the amount of light beam having a wavelength range of 450 nm or more and 900 nm or less incident on the imaging device such as the image sensor 405 can be uniformed, and the visible light image and the infrared light image can be read well.

### THIRD ASPECT

In the image reading device according to the first aspect, the mirror having a reflectance of 93% or more has a reflectance uniformity of 96% or more to a light beam having a wavelength range of 450 nm or more and 900 nm or less at a reflection angle of 45°. The reflectance uniformity is defined by the following expression, (minimum reflectance)/(maximum reflectance)×100%.

As a result, as described in an embodiment, the amount of light beam having a wavelength range of 450 nm or more and 900 nm or less incident on the imaging device such as the image sensor 405 can be uniformed, and the visible light image and the infrared light image can be read well.

### FOURTH ASPECT

In the image reading device according to any one of the first to third aspects, the mirror having a reflectance of 93% or more or a reflectance uniformity of 96% or more to a light beam having a wavelength range of 450 nm or more and 900 nm or less at a reflection angle of 45° has reflectance characteristics equivalent to those at a reflection angle of 5°.

As a result, as described in an embodiment, the mirror is less likely to depend on the reflection angle. Thus, even if a wide angle lens is used and the difference between a reflection angle (0°) at the center of the mirror in the main scanning direction and another reflection angle (half angle of view of the lens) at the end in the main scanning direction is large, the difference between the amount of light beam after reflection at the center in the main scanning direction and the amount of light beam after reflection at the end in the main scanning direction can be reduced. As a result, as described in an embodiment, the amount of light beam having a wavelength range of 450 nm or more and 900 nm or less incident on the imaging device such as the image sensor 405 can be uniformed in the main scanning direction, and the brightness of the read image can be uniformed in the main scanning direction. In addition, in the visible light image, the colors at the center and the end in the main scanning direction can be uniformized.

### FIFTH ASPECT

In the image reading device according to any one of the first to fourth aspects, the mirror having a reflectance of 93% or more or a reflectance uniformity of 96% or more includes a surface reflection mirror made of a metal film material of silver. As a result, as described in the embodiment, the reflectance of a light beam having a wavelength range of 450 nm or more and 900 nm or less can be increased to 93% or more, and a reflectance uniformity in the wavelength range can be increased to 93% or more. Further, the reflectance at the reflection angle of 5° can be the same as the reflectance at the reflection angle of 45°.

### SIXTH ASPECT

In the image reading device according to any one of the first to fifth aspects, the mirror having a reflectance of 93% or more or a reflectance uniformity of 96% or more has a smallest mirror area among the multiple mirrors. However, as described in an embodiment, the mirror such as a silver mirror having a reflectivity of 93% or more or the mirror having a reflectance uniformity of 93% or more is expensive. Thus, since the mirror having the smallest mirror area among the multiple mirrors is used as the mirror having a reflectance of 93% or more or the mirror having a reflectance uniformity of 96% or more, an increase in the cost of the apparatus can be prevented.

### SEVENTH ASPECT

In the image reading device according to any one of the first to sixth aspects, the visible light source such as the white point light source 501, the infrared light source such as the infrared point light source 701, multiple mirrors, and an imaging device such as the image sensor 405, a lens to image an image of a document on the receiving surface of the imaging device are arranged in a movable frame 408. However, as described in an embodiment, the number of mirrors is larger than that of the differential mirror system illustrated in FIG. 12 to increase the imaging distance within the limited space of the frame 408. Thus, the effect of the decrease in the amount of light beam by the mirror is larger than that in the differential mirror system. Further, the lens needs to be disposed in a limited space of the housing, and a large lens cannot be used, and the half angle of view of the lens becomes larger than that of the differential mirror system. As a result, the difference in the reflection angle between the center in the main scanning direction and the end in the main scanning direction becomes large. Thus, the multiple mirrors include at least one mirror having a reflectance of 93% or more or a reflectance uniformity of 96% or more so that the loss of the amount of light beam due to the mirror can be effectively prevented, and the amount of light beam incident of the imaging device in the main scanning direction can be uniformed.

### EIGHTH ASPECT

An image reading device such as a scanner unit 10 includes a visible light source such as a white point light source 501 to irradiate a document with a visible light beam, an infrared light source such as an infrared point light source 701 to irradiate the document with an infrared light beam, and multiple mirrors disposed in optical paths of the visible light beam and the infrared light beam from the document to an imaging device such as an image sensor 405. The multiple mirrors include at least one mirror of a surface reflection mirror made of a metal reflection film material of silver. As a result, as described in an embodiment, the multiple mirrors include at least one high reflectance mirror having a reflectance of 93% or more in a wavelength range of 450 nm or more and 900 nm or less and a reflectance uniformity of 96% or more in a wavelength range of 450 nm or more and 900 nm or less. In such a high reflectance mirror, the reflectance when the reflectance angle is 45° is equivalent to the reflectance when the reflectance angle is 5°. Accordingly, the visible light image and the infrared light image of the document can be read well.

### NINTH ASPECT

An image forming apparatus includes an image reading device such as the image reading device 130 to read a document and an image forming device to form an image on a sheet. The image reading device includes the image reading device according to any one of the first to eighth aspects. Accordingly, a high-quality image can be copied.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. An image reading device comprising:
a visible light source to irradiate a document with a visible light beam;
an infrared light source to irradiate the document with an infrared light beam; and
multiple mirrors disposed in optical paths of the visible light beam and the infrared light beam from the document to an imaging device,
wherein the multiple mirrors include at least a mirror having a reflectance of 93% or more, at a reflection angle of 45°, to a light beam having a wavelength range of 450 nm or more and 900 nm or less.

2. The image reading device according to claim 1,
wherein the mirror having the reflectance of 93% or more has a reflectance uniformity of 96% or more, at the reflection angle of 45°, to a light beam having the wavelength range of 450 nm or more and 900 nm or less,
the reflectance uniformity being defined by a following expression,
(minimum reflectance/maximum reflectance)×100%.

3. The image reading device according to claim 1,
wherein the mirror having the reflectance of 93% or more, at the reflection angles of 45°, to the light beam having the wavelength range of 450 nm or more and 900 nm or less has a first reflectance characteristic, and
the mirror having the reflectance of 93% or more, at the reflection angles of 5°, to the light beam having the wavelength range of 450 nm or more and 900 nm or less has a second reflectance characteristic equivalent to the first reflectance characteristic.

4. The image reading device according to claim 1,
wherein the mirror having the reflectance of 93% or more includes a surface reflection mirror made of a metal film material of silver.

5. The image reading device according to claim 1,
wherein the mirror having the reflectance of 93% or more has the smallest mirror area among a mirror area of each of the multiple mirrors.

6. The image reading device according to claim 1, further comprising:
an imaging device having a light receiving surface to receive the light beam:
a lens to image an image of the document at the light receiving surface of the imaging device; and
a frame movable along a surface of the document,
wherein the visible light source, the infrared light source, the multiple mirrors, the imaging device, and the lens are disposed on the frame.

7. An image forming apparatus comprising:
the image reading device according to claim 1 to read an image on the document; and
an image forming device to form the image, read by the image reading device, on a sheet.

8. An image reading device comprising:
a visible light source to irradiate a document with a visible light beam;
an infrared light source to irradiate the document with an infrared light beam; and
multiple mirrors disposed in optical paths of the visible light beam and the infrared light beam,
the multiple mirrors including at least a mirror having a reflectance uniformity of 96% or more, at a reflection angle of 45°, to a light beam having a wavelength range of 450 nm or more and 900 nm or less,
wherein the reflectance uniformity is defined by a following expression,
(minimum reflectance/maximum reflectance)×100%.

9. The image reading device according to claim 1,
wherein the mirror having the reflectance uniformity of 96% or more, at the reflection angles of 45°, to the light beam having the wavelength range of 450 nm or more and 900 nm or less has a first reflectance characteristic, and
the mirror having the reflectance uniformity of 96% or more, at the reflection angles of 5°, to the light beam having the wavelength range of 450 nm or more and 900 nm or less has a second reflectance characteristic equivalent to the first reflectance characteristic.

10. The image reading device according to claim 8,
wherein the mirror having the reflectance uniformity of 96% or more includes a surface reflection mirror made of a metal film material of silver.

11. The image reading device according to claim 8,
wherein the mirror having the reflectance uniformity of 96% or more has the smallest mirror area among a mirror area of each of the multiple mirrors.

12. The image reading device according to claim 8, further comprising:
an imaging device having a light receiving surface to receive the light beam:
a lens to image an image of the document at the light receiving surface of the imaging device: and
a frame movable along a surface of the document;
wherein the frame disposes the visible light source, the infrared light source, the multiple mirrors, the imaging device, and the lens in the frame.

13. An image forming apparatus comprising:
the image reading device according to claim 8 to read an image on the document; and
an image forming device to form the image, read by the image reading device, on a sheet.

14. An image reading device comprising:
a visible light source to irradiate a document with visible light beam;
an infrared light source to irradiate the document with an infrared light beam; and
multiple mirrors disposed in optical paths of the visible light beam and the infrared light beam from the document to an imaging device,
wherein the multiple mirrors include at least a surface reflection mirror made of a metal film material of silver.

15. An image forming apparatus comprising:
the image reading device according to claim 14 to read an image on the document; and
an image forming device to form the image, read by the image reading device, on a sheet.
